(19) United States
(12) Patent Application Publication
(10) Pub. No.: US 2019/0393691 A1
(43) Pub. Date: Dec. 26, 2019

(54) APPARATUS FOR TRANSMISSION LINE DEICING AND REACTIVE POWER COMPENSATION

(71) Applicant: Renchang Dai, Sammamish, WA (US)

(72) Inventor: Renchang Dai, Sammamish, WA (US)

(21) Appl. No.: 15/986,535

(22) Filed: May 22, 2018

(51) Int. Cl. H02G 7/16; H02M 5/10; H02J 3/20

(52) U.S. Cl. CPC H02G 7/16; H02J 3/20; H02M 5/10

(57) ABSTRACT

An apparatus for deicing and compensating reactive power is a mobile apparatus eWatch that includes a primary coil generating electromagnetic force, wherein a circuit comprises a voltage source and a switcher, and reactive power compensator that comprises an AC/AC converter and a reactive power compensating coil. The apparatus comprises blades to remove snow and ice.

### BACKGROUND OF THE INVENTION

The teachings herein relate generally to techniques for transmission line deicing and reactive power compensation.

In winter, utilities are facing snow and ice coating on transmission line stressing and potentially damaging the transmission line. Snow and ice removal from transmission line in winter is dangerous, expensive, and time consuming using manpower or helicopter. Heavy snow and ice coating will damage transmission tower and line leading to cascade line trip and power grid blackout.

In the case of reactive power compensation, conventional transmission line reactive power compensation as fixed shunt device and series device are static. Switched shunt device, SVC (Static Var Compensator) and STATCOM (Static Synchronous Compensator) are fixed at terminal of line section. They are incapable of compensating reactive power in a mobile way at different location for varied operation condition. The state of the present art without the present invention does not provide reactive power desired in many scenarios.

In the case of transmission line in remote area, hush winter weather condition, using manpower or helicopter to remove snow and ice are often impracticable. The present invention provides an apparatus to remove snow and ice, and compensate reactive power.

Efforts involving conventional line deicing and reactive power compensation have typically been designed separately by using separate approach and device. Mobility is not well achieved by conventional approach and device.

The invented apparatus is a mobile device which moves along transmission line. The apparatus equips blades to remove snow and ice in winter. The apparatus also equips converter controlled device to provide reactive power dynamically at the desired location of transmission line.

The mobility of the apparatus is critical to remove snow and ice along the line, and compensate reactive power at the desired moving location.

This invention will describe a technique for timely removing snow and ice when they are forming at early stage, and compensating reactive power at the desired point of transmission line.

### BRIEF DESCRIPTION OF THE INVENTION

The above discussed and other drawbacks and deficiencies of present state of the art are overcome or alleviated by the teachings disclosed herein.

Disclosed is a mobile apparatus for transmission line deicing and compensating reactive power, wherein blades and converter controlled reactive power compensator are equipped in the apparatus.

Also disclosed is primary coil layout to create desired electric magnetic force, which includes a passive and/or active coil for high voltage direct current line, high voltage alternating current line, communication line, and other lines applicable.

The features and advantages of the present invention will be appreciated and understood by those skilled in the art from the following detailed description and drawings.

### BRIEF DESCRIPTION OF THE DRAWINGS

Referring now to the drawings wherein like elements are numbered alike in the several Figures, wherein:

FIG. 1 is a schematic diagram illustrating aspects of a mobile apparatus for an Alternating Current transmission line application;

FIG. 2 is a schematic diagram illustrating aspects of a mobile apparatus for a Direct Current transmission line application;

FIG. 3 depicts an embodiment of the mobile apparatus primary coil structure;

FIG. 4 depicts aspects of electromagnetic force on the primary coil of the embodied mobile apparatus for a Direct Current transmission line application;

FIG. 5 depicts aspects of electromagnetic force on the primary coil of the embodied mobile apparatus for an Alternating Current transmission line application when alternating current is positive;

FIG. 6 depicts aspects of electromagnetic force on the primary coil of the embodied mobile apparatus for an Alternating Current transmission line application when alternating current is negative;

FIG. 7 depicts current direction of the primary coil of the mobile apparatus for a Direct Current transmission line application;

FIG. 8 depicts current direction of the primary coil of the mobile apparatus for an Alternating Current transmission line application;

FIG. 9 depicts the primary coil of the mobile apparatus is powered by battery for a Direct Current transmission line application;

FIG. 10 depicts the primary coil of the mobile apparatus is powered by a converter and a converter transformer for a Direct Current transmission line application;

FIG. 11 depicts the primary coil of the mobile apparatus is powered by a transformer for an Alternating Current transmission line application;

FIG. 12 depicts that the mobile apparatus reactive power compensating coil provides reactive power for an Alternating Current transmission line application;

FIG. 13 depicts embodied blades of the mobile apparatus to remove snow and ice.

### DETAILED DESCRIPTION THE INVENTION

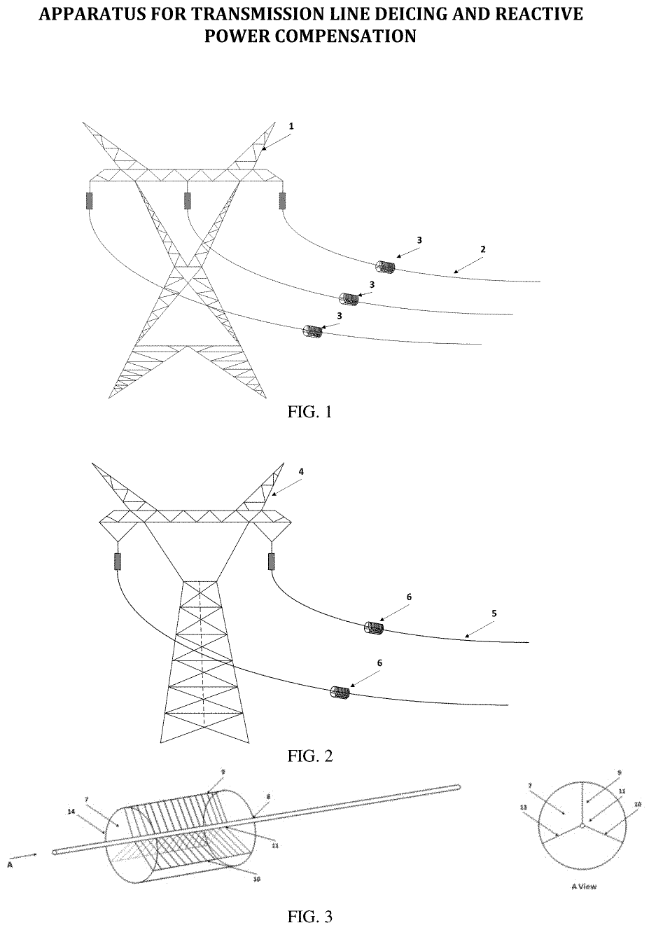

Referring to FIG. 1, there is shown an exemplary architecture for a mobile apparatus 3 for an Alternating Current (AC) transmission line application, also referred to herein as an AC eWatch. The AC eWatch travels on AC transmission line 2 connected in between two AC transmission towers 1. FIG. 1 depicts each phase of the transmission line which equips an AC eWatch. They move collaboratively or independently at same or different spend and/or direction for the best performance.

The similar mobile apparatus 6 permits for Direct Current (DC) transmission line application, also referred to herein as a DC eWatch 6 of which is provided in FIG. 2. The DC eWatch travels on DC transmission line 5 connected in between two DC transmission towers 4. The teaching herein may be applied to other lines, a non-limiting example of which is provided in FIG. 1 and FIG. 2.

Note that three eWatchs as depicted in FIG. 1 illustrates but two eWatchs for DC transmission line in FIG. 2.

As used herein, the terms “Alternating Current Transmission Line” and “Direct Current Transmission Line” make reference to eWatch designated for deicing and compensating reactive power respectively. Again, this convention is merely illustrative of the teachings herein. That is, use of “Alternating Current Transmission Line” and “Direct Current Transmission Line” are non-limiting examples of the use of the eWatch for deicing and compensating reactive power. The eWatch can be used for general lines. Such lines as may be distribution line, communication line include the line with or without current flowing through the line.

FIG. 3 depicts aspects of an embodiment of an eWatch structure having two hubs 7, 8, where a tube 11 is connected in between the two hubs in the middle. Three primary coils 9, 10, 13 (in A view) are wound symmetrically in between the tube 11 and the frame 14. Windings of each primary coil 9, 10, 13 connected in between the tube 11 and the frame 14 are in parallel. Note that windings are not coated.

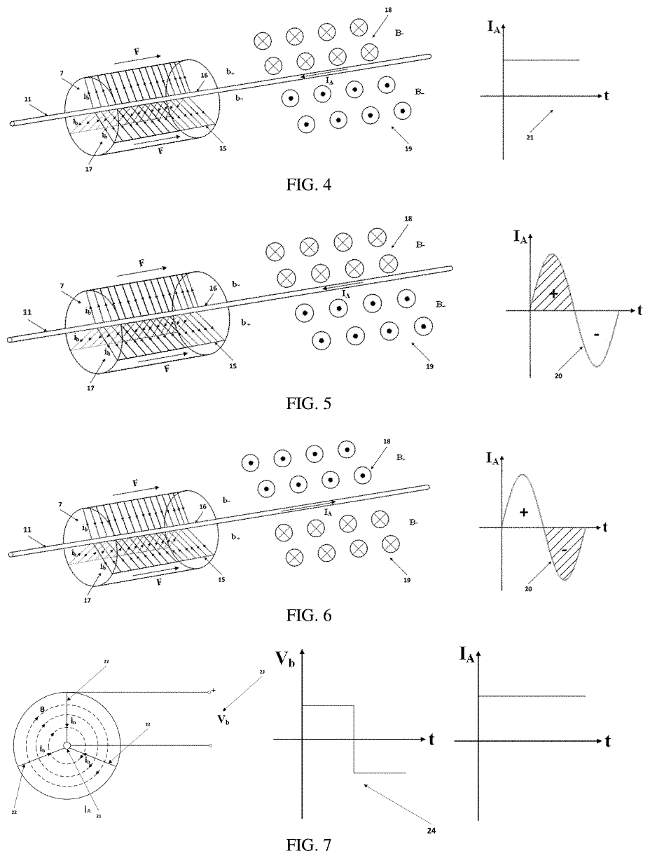

FIG. 4 depicts aspects of electromagnetic force on the primary coil of the embodied mobile apparatus for a Direct Current transmission line application. In this embodiment, the current I_{A} 21 is the direct current of the Direct Current transmission line. I_{A} generates negative magnetic field 18 that points into the page as denoted by B− and positive magnetic field 19 that points out of the page as denoted by B+. When direct currents 17 as denoted by i_{b} are injected to the three primary coils from the tube 16 to the frame 15, electromagnetic force as denoted by F is generated to move the eWatch. To change the eWatch moving direction, the current i_{b} direction is reversed by switching polarity of the frame 15 and the tube 16, thus change the direction of electromagnetic force F.

FIG. 5 depicts aspects of electromagnetic force on the primary coil of the embodied mobile apparatus for an Alternating Current transmission line application when alternating current is positive. In this embodiment, the current I_{A} 20 is the alternating current of the Alternating Current transmission line. When I_{A} is positive, it generates negative magnetic field 18 that points into the page as denoted by B− and positive magnetic field 19 that points out of the page as denoted by B+. When alternating currents 17 as denoted by i_{b} are injected to the three primary coils from the tube 16 to the frame 15, electromagnetic force as denoted by F is generated to move the eWatch. To change the eWatch moving direction, the current i_{b} direction is reversed, thus change the direction of electromagnetic F.

FIG. 6 depicts aspects of electromagnetic force on the primary coil of the embodied mobile apparatus for an Alternating Current transmission line application when alternating current is negative. In this embodiment, the current I_{A} 20 is the alternating current of the Alternating Current transmission line. When I_{A} is negative, it generates positive magnetic field 18 that points out of the page as denoted by B+ and negative magnetic field 19 that points into the page as denoted by B−. When alternating currents 17 as denoted by i_{b} are injected to the three primary coils from the frame 15 to the tube 16, electromagnetic force as denoted by F is generated to move the eWatch. To change the eWatch moving direction, the current i_{b} direction is reversed, thus change the direction of electromagnetic F.

FIG. 7 depicts current direction of the primary coil of the mobile apparatus for a Direct Current transmission line application. Direct Current voltage source 23 as denoted by V_{b} provides currents 22 as denoted by i_{b} from the frame to the tube. The electromagnetic force (not shown in FIG. 7) is generated when i_{b} is orthogonal to electromagnetic field as denoted by B. The electromagnetic field B is created by Direct Current 21 as denoted as I_{A}. Switching voltage polarity as depicted by 24 will change the direction of current i_{b}, thus change the direction of electromagnetic force F.

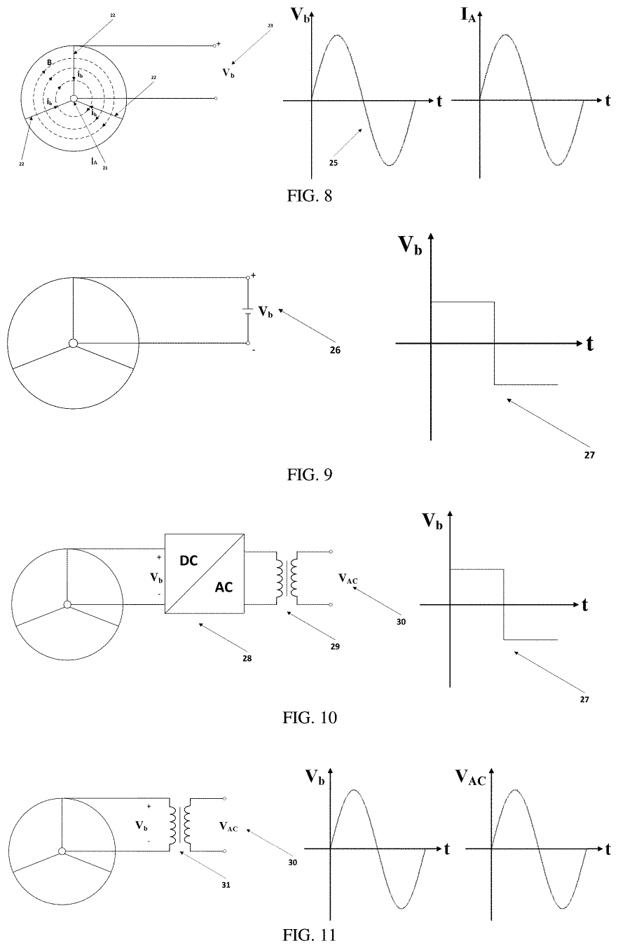

FIG. 8 depicts current direction of the primary coil of the mobile apparatus for an Alternating Current transmission line application. Alternating voltage source 23 as denoted by V_{b} provides currents 22 as denoted by i_{b} from the frame to the tube when V_{b} is positive. The electromagnetic force (not shown in FIG. 8) is generated when i_{b} is orthogonal to electromagnetic field as denoted by B. The electromagnetic field B is created by Alternating Current 21 as denoted as I_{A}. An exemplary waveform of V_{b} as denoted by 25 is depicted in FIG. 8. The teachings herein can use any other waveform. Switching voltage polarity as depicted by 25 will change the direction of current i_{b}, thus change the direction of electromagnetic force F as desired.

Referring to FIG. 9, an exemplary embodiment of the voltage source where a battery is applied is depicted. For convenience, this embodiment is referred to herein as Option A. In this figure, current i_{b} is generated by battery voltage 26. Battery voltage is denoted by V_{b}. Switching voltage polarity as depicted by 27 will change the direction of current i_{b}, thus change the direction of electromagnetic force F as desired.

Referring to FIG. 10, an exemplary embodiment of the voltage source where a rectifier 28 and a transformer 29 are depicted. For convenience, this embodiment is referred to herein as Option B. In this figure, current i_{b} is generated by voltage V_{b}. The Alternating Voltage 30 as denoted by V_{AC} comes from either Alternating Current Transmission line or any other source. Switching voltage polarity as depicted by 27 will change the direction of current i_{b}, thus change the direction of electromagnetic force F as desired.

FIG. 11 depicts mobile apparatus primary coil is powered by a transformer 31 for an Alternating Current transmission line application where the Alternating Voltage 30 as denoted by V_{AC} comes from either Alternating Current Transmission line or any other source.

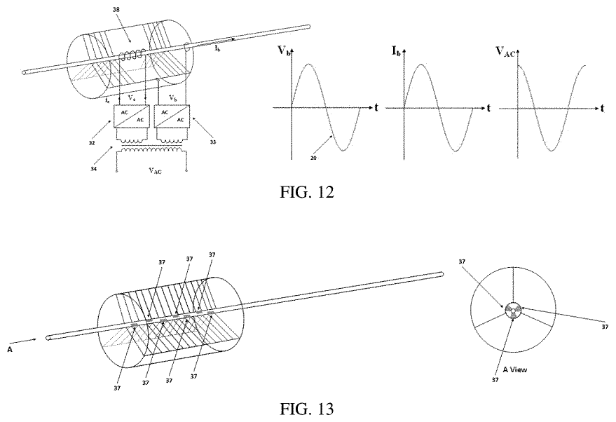

FIG. 12 depicts the reactive power compensating coil 38 of the mobile apparatus provides reactive power for an Alternating Current transmission line application. In this figure, the transformer tertiary winding 34 connecting to the reactive power compensating coil 38 through a AC/AC converter 32. The converter is designed to flexibly regulate voltage as denoted by Vc to provide reactive power current i_{c} to transmission line. A non-limiting example of waveform and phase shifting is shown as V_{AC} in the figure. The waveform and phase shifting angle can be in any form and possibility as desired. Therefore, it is intended that the invention not be limited to the exemplary waveform and phase shifting in the figure. The transformer secondary winding connecting to the hub and the tube through another AC/AC converter 33. The converter is designed to flexibly regulate voltage as denoted by V_{b} to provide current i_{b} to the mobile apparatus primary coil.

FIG. 13 depicts embodied blades of the mobile apparatus to remove snow and ice where blades 37 are mounted around the tube entangling to transmission line or any other line applicable. The blades can be withdrawn when snow and/or ice is not present to avoid damage onto transmission line. The mobile device with blades can rotate around transmission line to improve snow/ice removal effectiveness.

While the invention has been described with reference to an exemplary embodiment, it will be understood by those skilled in the art that various changes may be made and equivalents may be substituted for elements therefore, it is intended that the invention not be limited to the particular embodiment disclosed as the best mode contemplated for carrying out for invention, but that the invention will include all embodiments falling within the scope of the appended claims.

What is claimed is:

1. A mobile apparatus (eWatch) of line deicing and reactive power compensation, the eWatch comprising:
a mobile apparatus, wherein a primary coil connecting between a frame and a tube with current flowing in the primary coil to generate electromagnetic force in an electromagnetic field;
blades mounted around the tube entangling to transmission line or any other line applicable; and,
a reactive power compensating coil connecting to a AC/AC converter through a tertiary winding of a transformer.

2. The eWatch as in claim 1, wherein the primary coils are wound symmetrically in between the tube and the frame. The number of primary coils can be three or any other number.

3. The eWatch as in claim 1, wherein a circuit comprises a voltage source provides direct current or alternating current to the primary coil.

4. The eWatch as in claim 1, wherein a circuit comprises a switch to change the direction of current flowing in the primary coil.

5. The eWatch as in claim 1, wherein the voltage source comprises battery to provide direct current flowing in the primary coil.

6. The eWatch as in claim 5, wherein the direct current flowing in the primary coil is changeable to generate controllable electromagnetic force on the eWatch.

7. The eWatch as in claim 1, wherein the voltage source comprises a DC transmission line DC voltage through a DC/DC converter to provide direct current flowing in the primary coil.

8. The eWatch as in claim 7, wherein the direct current flowing in the primary coil is changeable to generate controllable electromagnetic force on the eWatch.

9. The eWatch as in claim 1, wherein the voltage source comprises an AC transmission line AC voltage through a converter and converter transformer to provide direct current flowing in the primary coil.

10. The eWatch as in claim 9, wherein the direct current flowing in the primary coil is changeable to generate controllable electromagnetic force on the eWatch.

11. The eWatch as in claim 1, wherein the voltage source comprises a transformer transferring transmission line AC voltage to provide alternating current flowing in the primary coil.

12. The eWatch as in claim 11, wherein the alternating current flowing in the primary coil is changeable to generate controllable electromagnetic force on the eWatch.

13. The eWatch as in claim 11, wherein the AC voltage to provide alternating current is in the phase of the current flowing through the AC transmission line.

14. The eWatch as in claim 1, wherein an apparatus comprises blades around the tube entangling to line.

15. The apparatus as in claim 14, wherein an electromagnet is equipped to withdraw the blades when snow and/or ice is not present to avoid damage onto line.

16. The apparatus as in claim 14, wherein the blades rotate around transmission line to remove snow and/or ice.

17. The eWatch as in claim 1, wherein an apparatus comprises a reactive power compensating coil winding around line.

18. The apparatus as in claim 17, wherein an AC/AC converter through a tertiary winding of a transformer is equipped.

19. The apparatus as in claim 17, wherein the magnitude of the reactive power compensating coil output voltage is changeable to generate controllable reactive power.

20. The apparatus as in claim 17, wherein the phase shifting angle of the reactive power compensating coil output voltage is changeable to generate controllable reactive power.
